(19) United States
(12) Patent Application Publication
(10) Pub. No.: US 2003/0051364 A1
(43) Pub. Date: Mar. 20, 2003

(54) Method and apparatus for positioning a wafer chuck

(76) Inventor: Bernardo Donoso, San Jose, CA (US)

Correspondence Address: PATENT COUNSEL, APPLIED MATERIALS, INC., Legal Affairs Department, P.O. BOX 450A, Santa Clara, CA, 95052, US

(21) Appl. No.: 10/218,171

(22) Filed: Aug. 13, 2002

Related U.S. Application Data
(60) Provisional application No. 60/312,338, filed on Aug. 14, 2001.

(51) Int. Cl. G01D 21/00

(52) U.S. Cl. 33/645

(57) ABSTRACT

A wafer chuck comprises a wafer chucking surface, a fixable rotary which allows the wafer chucking surface to rotate to adjust and fix pitch, and a planar joint which allows the wafer chucking surface to translate and fix position in order to center the wafer chucking surface with respect to another surface. An inventive assembly comprises a wafer chucking surface, and a wafer exchange surface, opposite the wafer chucking surface. The wafer exchange surface is mounted via a fixable rotary joint and a planar joint and allows the wafer exchange surface to rotate and to translate so as to fix the pitch and position of the wafer exchange surface to level and center the wafer exchange surface relative to the wafer chucking surface. Alternatively the fixable rotary and/or planar joints may be coupled to the wafer chucking surface. A calibration jig having rough and fine centering pins may be included.

This application claims priority from U.S. Provisional Patent Application Serial No. 60/312,338, filed Aug. 14, 2001, which is hereby incorporated by reference herein in its entirety.

### FIELD OF THE INVENTION

The present invention relates to a method and apparatus for positioning a wafer chuck. More specifically, the invention relates to a method and apparatus for calibrating a wafer chucking surface relative to a wafer exchange surface, such that the wafer chuck is both level and concentric relative to the wafer exchange surface.

### BACKGROUND

A number of semiconductor fabrication processes hold a semiconductor wafer in place via an apparatus conventionally referred to as a wafer chuck. A wafer chuck attracts a wafer to a flat surface known as a wafer chucking surface, thus allowing the wafer to be held in place without using clamps which would by necessity cover a portion of the wafer's edge. Wafer chucks provide access to a wafer's entire circumference.

Typically, to attract the wafer the wafer chucking surface may selectively generate either an electrostatic charge or vacuum suction so as to selectively hold or release the wafer, as is known in the art. In order to properly attract and hold the wafer, the wafer chucking surface must make even contact across the flat surface of the wafer. Accordingly, in automated systems where the wafer is first placed on a wafer exchange surface and the wafer chucking surface is then brought into contact with the wafer, it is important that the wafer chucking surface and the wafer exchange surface be level relative to each other.

Likewise, most processes require a wafer to be centered on the wafer chucking surface (e.g., so that processes may be evenly and repeatably performed from one wafer to the next). Wafer centering is particularly important when a wafer is rotated and a process such as cleaning or etching is performed on the wafer's edge, as any eccentricity will result in eccentric processing of the wafer's edge.

Wafer chucking surfaces and/or wafer exchange surfaces must therefor be mounted so as to allow for rotation (leveling/pitch adjustment) and translation (centering) so they may be calibrated to make them level and concentric relative to each other. In practice this calibration step may be performed manually, and may be time consuming and difficult to perform repeatably.

### SUMMARY

An inventive wafer chuck comprises a wafer chucking surface, at least one fixable rotary joint coupled to the wafer chucking surface so as to allow the wafer chucking surface to rotate in order to selectively adjust and fix the pitch of the wafer chucking surface; and at least one planar joint coupled to the wafer chucking surface so as to selectively allow the wafer chucking surface to translate and to fix the position of the wafer chucking surface in order to center the wafer chucking surface with respect to another surface.

A method of calibrating a wafer chucking surface relative to a wafer exchange surface comprises mounting at least one of the wafer chucking surface and the wafer exchange surface via a fixable rotary joint and mounting at least one of the wafer chucking surface and the wafer exchange surface via a fixable planar joint. Thereafter one or more calibration jigs having features that kinematically interface with features of the surfaces to be leveled and centered, is coupled to a first one of wafer chucking surface or the wafer exchange surface so as to be concentric therewith, and the wafer chucking surface and the wafer exchange surface are brought into flat contact with opposite faces of the calibration jig. The wafer chucking surface and wafer exchange surface are leveled and centered relative to each other due to kinematic coupling with the calibration jig. The rotary and planar movement of the wafer chucking surface and/or the wafer exchange surface are fixed in one or more steps such that the two surfaces are held in their level and centered position.

An inventive assembly comprises a wafer chucking surface, and a wafer exchange surface, opposite the wafer chucking surface. At least one fixable rotary joint is coupled to the wafer exchange surface so as to allow the wafer exchange surface to rotate in order to selectively adjust and fix the pitch of the wafer exchange surface, and at least one planar joint is coupled to the wafer exchange surface so as to selectively allow the wafer exchange surface to translate and to fix the position of the wafer exchange surface in order to center the wafer exchange surface with respect to the wafer chucking surface. Alternatively one or both of the fixable rotary and/or planar joints may be coupled to the wafer chucking surface.

The assembly may further comprise one or more calibration jigs adapted to couple concentrically to the wafer exchange surface. The one or more calibration jigs may have a first planar surface having a rough calibration pin extending perpendicularly therefrom and a second planar surface, having a second calibration pin extending perpendicularly therefrom. The second pin may have a larger cross section than the first pin, and the wafer chucking surface may have one or more openings adapted to receive the first pin and the second pin. The wafer chucking surface and the calibration jig are adapted such that the wafer exchange surface and the wafer chucking surface are roughly concentric when the first pin extends into the opening of the wafer chucking surface and such that the wafer chucking surface and the wafer exchange surface are finely concentric when the second calibration pin extends into the opening of the wafer chucking surface. In an alternative embodiment the calibration jig(s) may be coupled to the wafer chucking surface and the pins may extend into features on the wafer exchange surface.

Other features and advantages of the present invention will become more fully apparent from the following detailed description, the appended claims and the accompanying drawings.

### BRIEF DESCRIPTION OF THE DRAWINGS

FIG. 1 is a top plan view of a mounting apparatus having separate joints for fixing the level position and the concentric position of a surface mounted thereto;

FIG. 2 is a side isometric view of the mounting apparatus of FIG. 1;

FIG. 3 is an exploded side isometric view of the mounting apparatus of FIG. 1;

FIG. 4 is a side schematic view of an assembly comprising a chamber having the mounting assembly of FIG. 1 mounted to a wafer chucking surface, and showing a calibration jig used therein;

FIG. 5 is a side schematic view of the calibration jig of FIG. 4;

FIG. 6 is a flow chart useful in describing the calibration sequence performed via the assembly of FIG. 4; and

FIG. 7 is a side schematic view of an assembly comprising a chamber having the mounting assembly of FIG. 1 mounted to a wafer exchange surface, and showing a calibration jig used therein.

### DETAILED DESCRIPTION OF THE DRAWINGS

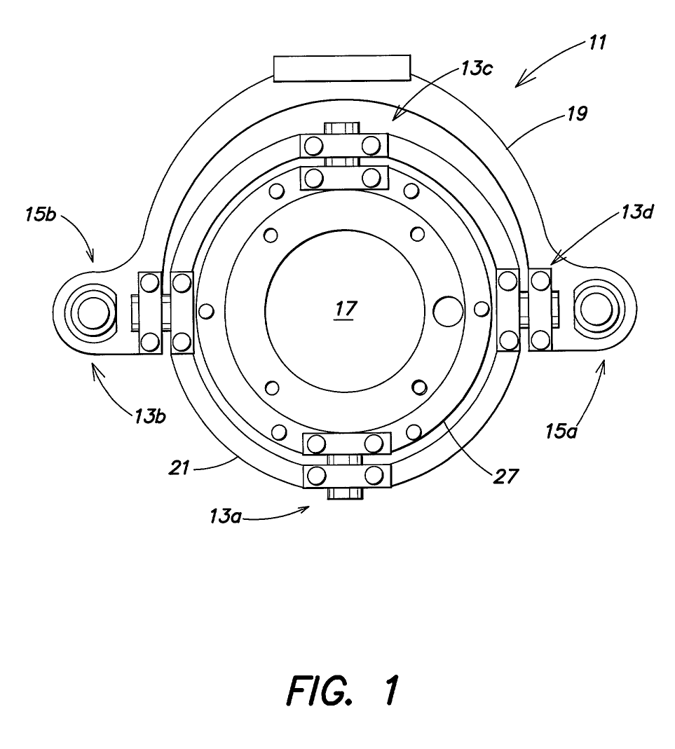

FIG. 1 is a top plan view of a mounting apparatus 11 having separate joints for fixing a level position and a concentric position of a surface mounted thereto. Specifically, the embodiment of FIG. 1 has four fixable rotary joints 13a-d and two fixable planar joints 15a-b, coupled so as to respectively allow a surface 17 mounted thereto (e.g., either a wafer chucking surface or a wafer exchange surface) to be leveled, via the rotary joints 13a-d, and to be centered, via the planar joints 15a-b.

A bracket 19 is provided for coupling the mounting apparatus 11 to a chamber wall (not shown) (or to a vertically moving slide (not shown) mechanism which moves the mounting apparatus 11 up and down) In the embodiment of FIG. 1, each of the rotary joints 13a-d allow rotation in a single direction. However, because the rotary joints 13a-d are positioned at evenly spaced locations around the surface 17 and are coupled to the surface 17 and the bracket 19 via an intermediate bracket 21, they allow the surface 17 to rotate in both the pitch and roll directions (relative to the bracket 19). Alternatively spherical rotary joints may be employed and the intermediate bracket 21 omitted.

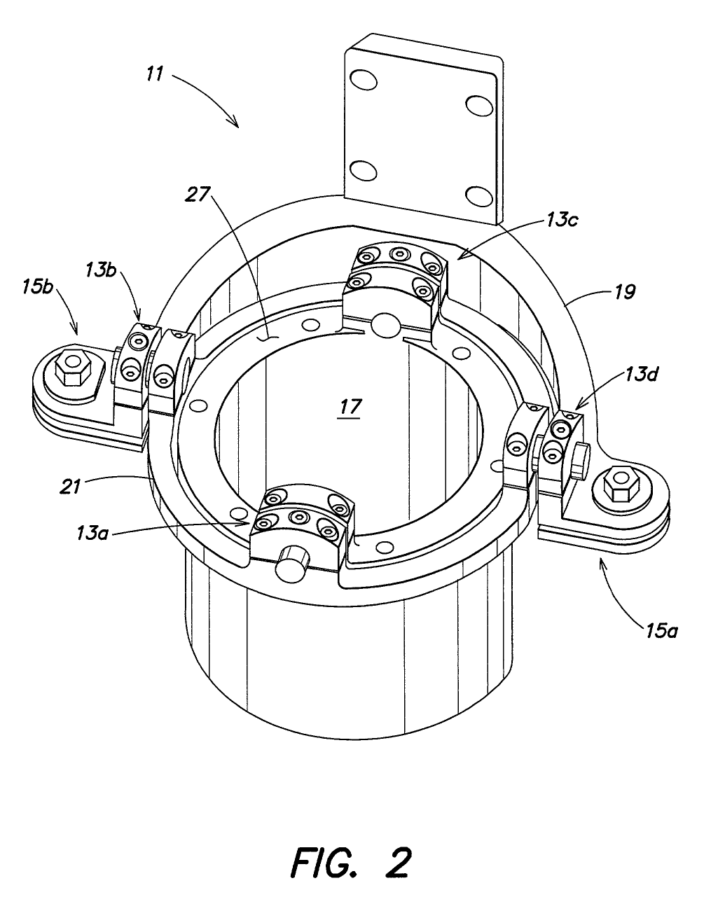

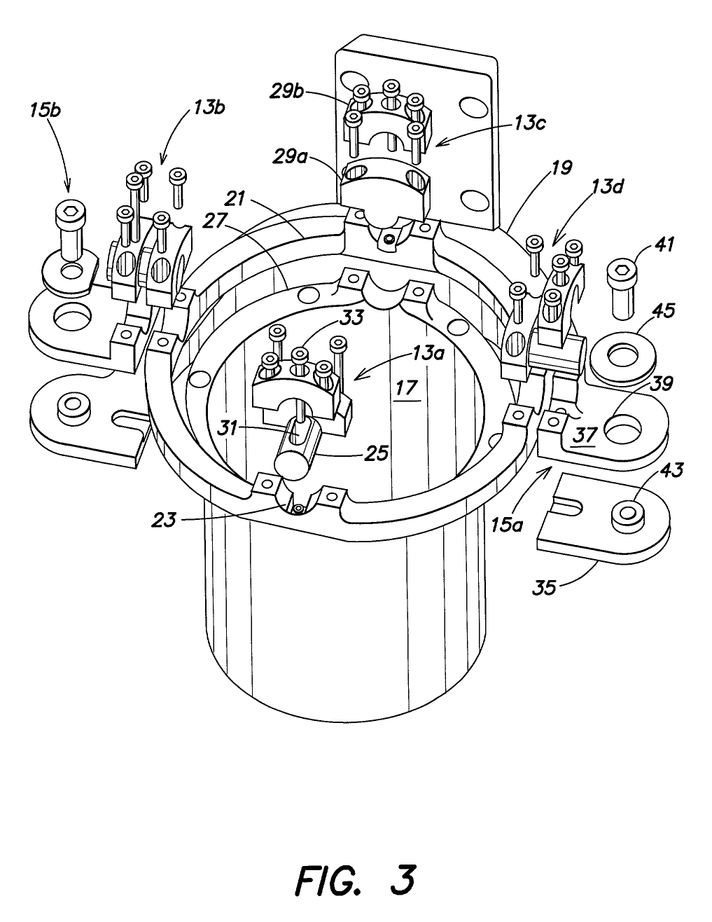

The planar joints 15a-b couple the surface 17 (in this embodiment via the intermediate bracket 21) to the mounting bracket 19, and allow the surface 17 to translate in any direction in the general plane of the surface 17. The specific mechanisms and operation of the rotary joints 13a-d and the planar joints 15a-b are best understood with joint reference to FIGS. 2 and 3.

FIG. 2 is a side isometric view, and FIG. 3 is an exploded side isometric view of the mounting apparatus 11 of FIG. 1. As shown in FIGS. 2 and 3, each rotary joint 13a-d comprises a female component 23 for receiving a male component 25. Both the female component 23 and the male component 25 are radiused in a single plane. Two opposing rotary joints 13a, 13c have female components 23 coupled to the intermediate bracket 21 and to a bracket 27 that surrounds (directly or indirectly) the surface 17 and male components 25 that extend between the two female components 23 and are rotatably coupled thereto via a pair of brackets 29a-b. In order to fix the rotary joint 13a, 13c in a desired position, a slot 31 is provided in the male component 25 and allows a fixing screw 33 to pass through an opening in the bracket 29b, through the slot 31 and into an opening in the female component 23 coupled to the intermediate bracket 21. Tightening of the fixing screw 33 prevents rotation between the intermediate bracket 21 and the surface bracket 27.

Similarly, two opposing rotary joints 13b, 13d have female components 23 coupled to the intermediate bracket 21 and to the mounting bracket 19 (indirectly via the planar joints 15a-b as described below), and have male components 25 that extend between the two female components 23 and are rotatably coupled thereto via a pair of brackets 29a-b. In order to fix the rotary joint 13b, 13d in a desired position a slot 31 is provided in the male component 25 and allows a fixing screw 33 to pass through an opening in the bracket 29b, through the slot 31 and into an opening in the female component 23 coupled to the mounting bracket 19. Tightening of the fixing screw 33 prevents rotation between the intermediate bracket 21 and the mounting bracket 19.

In the embodiment shown in FIGS. 2 and 3, the planar joints 15a-b comprise a first plate 35 which may be integral with the mounting bracket 19, and a second plate 37 which is coupled to the intermediate bracket 21 via the female component 23 and the male component 25, as described above. The second plate 37 has a large opening 39 that allows a fixing screw 41 to pass therethrough and thread into an opening 43 on the first plate 35. The surface 17 may thus translate in any direction by a distance that maintains the opening 43 within the footprint of the larger opening 39. Tightening of the fixing screw 41 (through a washer 45) prevents further translation between the surface 17 and the mounting bracket 19.

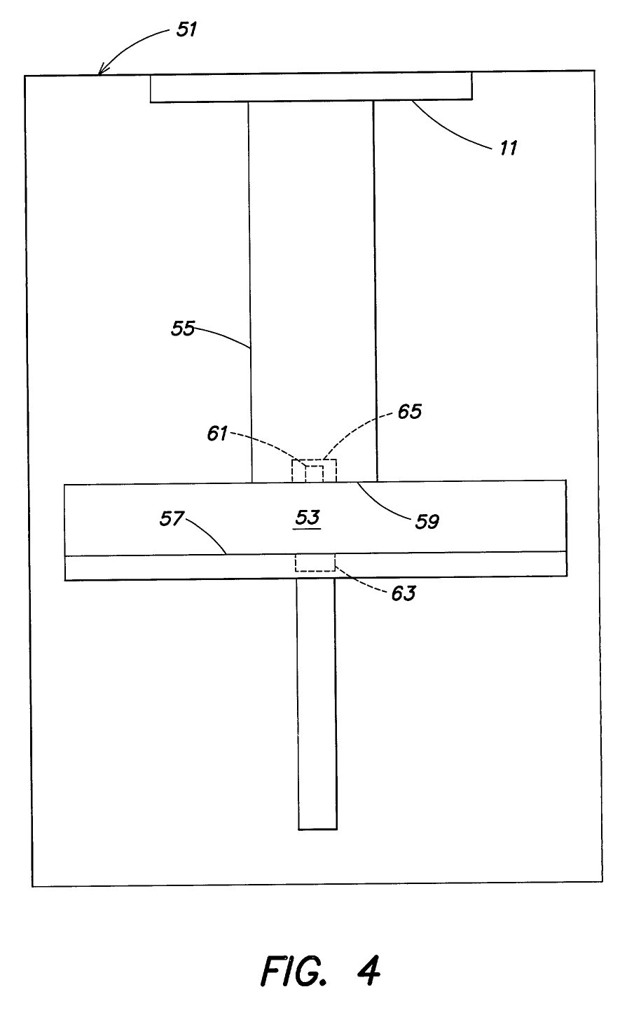

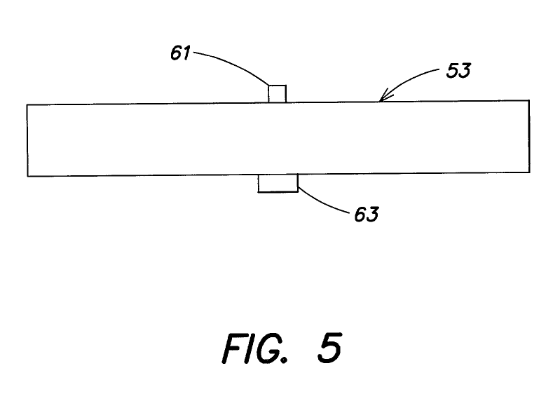

FIG. 4 is a side isometric view of an assembly comprising a chamber 51 having the mounting assembly 11 of FIG. 1 mounted therein and showing a calibration jig 53 in use. FIG. 5 is a side schematic view of the calibration jig 53. The chamber 51 is adapted to perform a process that requires wafer chucking, such as a process that rinses or etches material from the wafer's beveled edge. In the embodiment shown in FIG. 4, a wafer chuck 55 is mounted along a top surface of the chamber 51 via the mounting apparatus 11 of FIG. 1. A wafer exchange surface 57 (such as a hoop for supporting a wafer) is positioned below the wafer chuck 55, and a calibration plate 53 is shown positioned thereon. The wafer chuck 55 has a wafer chucking surface 59 through which vacuum, or electrostatic charge is applied so as to attract and hold a wafer in place on the wafer chucking surface 59. A motor (not shown) is coupled to the wafer chuck 55 so as to rotate the wafer chuck 55, and also so as to lift and lower the wafer chucking surface 59 to and from a position where the wafer chucking surface 59 may contact a wafer positioned on the wafer exchange surface 57.

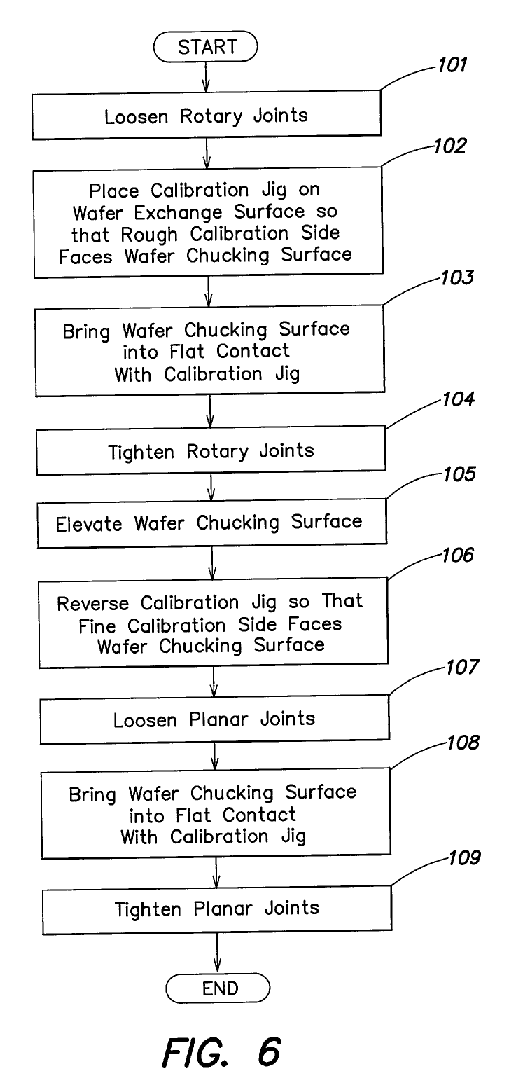

The calibration jig shown in FIG. 5 comprises a plate having two coplanar surfaces each of which has a pin extending perpendicularly from the center thereof. A first pin 61 which extends from a first side of the calibration jig 53 has a smaller cross-section (e.g., diameter) than the cross-section of a second pin 63 which extends from a second side of the calibration jig 53. The cross-section of the first pin 61 is selected so as to fit, with a loose tolerance (e.g., the diameter of the pin being 1 to 2 mm smaller than the receiving opening in the chuck), within an opening 65 located at the center of the wafer chucking surface 59, and the cross-section of the second pin 63 is selected so as to fit, with a close tolerance (e.g., the diameter of the pin being 0.01 to 0.08 mm smaller than the receiving opening in the chuck), within the opening 65 located at the center of the wafer chucking surface 59. Thus, the first pin 61 and the second pin 63 may be referred to as a rough calibration pin, and a fine calibration pin, respectively, as more fully understood with reference to FIG. 6, described below. it will be understood that in an alternative embodiment, the calibration pins may extend into openings on the wafer exchange surface, rather than on the wafer chucking surface.

FIG. 6 is a flowchart useful in describing a calibration sequence performed via the chamber assembly of FIG. 4. During a calibration sequence the rotary joints 13a-d are loosened (step 101), and the calibration jig 53 is placed on or coupled to the wafer exchange surface 57 in a centered position (e.g., manually centered, centered via kinematic coupling with the wafer exchange surface 57, etc.) with the rough calibration pin 61 facing the wafer chucking surface 59 (step 102). The wafer chucking surface 59 is then lowered so as to be brought into flat contact with the calibration jig 53 located on the wafer exchange surface 57 (step 103). In order for the wafer chucking surface 59 to come into flat, level contact with the wafer exchange surface 57, the wafer chucking surface 59 may rotate freely (due to the rotary coupling provided by the loosened rotary joints 13a-d) as it is pressed against the calibration jig 53. The first pin 61 may fit within the opening 65 on the wafer chucking surface 59 even though the wafer chucking surface 59 may be somewhat eccentric relative to the wafer exchange surface 57, and may have approached the wafer exchange surface 57 with a somewhat nonlevel orientation.

Thereafter the rotary joints 13a-d may be tightened (step 104), the wafer chucking surface 59 removed from contact with the calibration jig 53 (step 105), the calibration jig reversed such that the fine calibration pin 63 faces the wafer chucking surface 59 (step 106) the planar joints 15 loosened (step 107) and the wafer chucking surface 59 again brought into contact with the calibration jig 53 (step 108). Because the wafer chucking surface 59 and the wafer exchange surface 57 are level relative to each other, the opening 65 in the wafer chucking surface 59 will be able to accommodate the fine calibration pin 63. Because the opening 65 in the wafer chucking surface 59 and the fine calibration pin 63 are tightly toleranced, the wafer chucking surface 59 and the wafer exchange surface 57 will be both leveled and centered within a tight tolerance. Thereafter the planar joints 15a-b are tightened (step 109).

It will be understood that gross movement of the wafer chucking surface may be performed manually, for example so as to bring the wafer chucking surface within sufficient tolerance (level and center) so as to allow the rough calibration pin 61 to enter the opening 65 located on the wafer chucking surface 59. Likewise, further manual alignment may be employed to place the fine calibration pin 63 within the opening 65. Unlike a purely manual calibration process, the inventive process may be more repeatable and precise due to the kinematic coupling between the calibration jig 53, and the opening 65 in the wafer chucking surface 59. Further, because with the embodiment of FIGS. 1-4, the rotary and planar movements are performed by separate joints, the calibration process may be simplified, by breaking it into two simple steps rather than one more complex step. Although the inventive method described above benefits from the novel combination of the calibration jig and the mounting apparatus, it should be understood, that a mounting apparatus that performs rotary and linear movement with different joints (i.e., at least one set of joints that performs only linear or only rotary movements) is considered inventive, regardless of the inclusion of additional features for kinematic coupling with a jig, and that the use of a jig for kinematically leveling and centering a wafer chucking surface and a wafer exchange surface is also considered inventive, regardless of the specific mounting joint configuration.

The mounting apparatus shown is merely exemplary. Other mounting apparatuses may be employed, such as those that provide spherical rotary joints, those that employ joints that are both rotary and linearly fixable, whether each motion is fixed separately or at the same time (e.g., by a single screw). Likewise, the jig configuration may vary, as may the shape, location and type of kinematic features employed (e.g., the term “pin” is to be interpreted broadly). In an alternative embodiment, the jig may be integral with the wafer exchange location (e.g., kinematic features may selectively lift and lower therefrom and/or may also act as a wafer supporting feature).

The calibration pins and the openings into which they extend may be positioned at locations other than the center of the calibration jig, and different opening may be used to receive the rough and fine calibration pins.

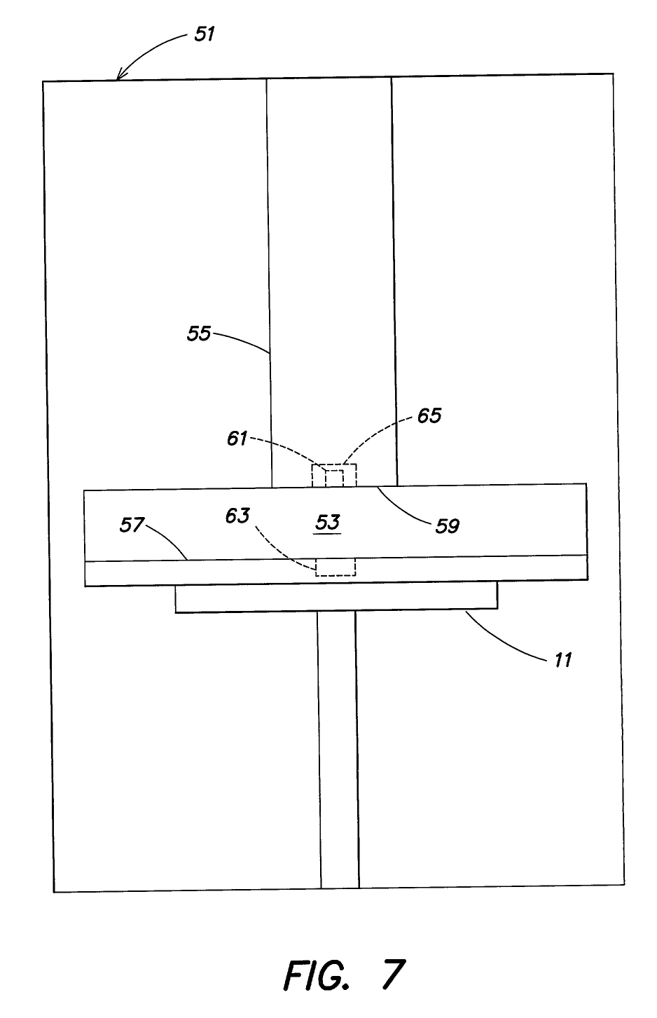

Finally, it should be understood that the inventive mounting apparatus may be mounted to the wafer exchange location (as shown in the side schematic view of FIG. 7), and the wafer exchange location may adjust its position, level and center. Likewise, the calibration jig may be placed on the wafer chucking surface, and the openings or features for receiving the calibration pins may be formed on the wafer exchange surface. Rather than a reversible calibration jig, a first calibration jig may be used for rough calibration and a second calibration jig may be used for fine calibration.

Accordingly; while the present invention has been disclosed in connection with exemplary embodiments thereof, it should be understood that other embodiments may fall within the spirit and scope of the invention, as defined by the following claims.

The invention claimed is:

1. A method of calibrating a wafer chucking surface, comprising:
providing a calibration jig having a rough calibration surface with a first pin extending therefrom, and a fine calibration surface with a second pin extending therefrom, the first and second surfaces being coplanar;
providing a wafer chucking surface having one or more openings adapted to receive the first and second pins, wherein the first pin is received with a looser tolerance than the second pin;
mounting the wafer chucking surface via a mounting assembly having at least one fixable rotary joint and at least one fixable planar joint;
placing the calibration jig on a wafer exchange surface with the rough calibration surface facing the wafer chucking surface;
bringing the wafer chucking surface into flat contact with the calibration jig placed on the wafer exchange surface, such that the wafer chucking surface and the wafer exchange surface are leveled relative to each other, and such that the first pin is received by one of the one or more openings on the wafer chucking surface;
fixing a rotary joint of the wafer chucking surface;
removing the contact between the wafer chucking surface and the calibration jig;
placing the calibration jig on the wafer exchange surface with the fine calibration surface facing the wafer chucking surface;
bringing the wafer chucking surface into flat contact with the calibration jig placed on the wafer exchange surface, such that the second pin is received by one of the one or more openings on the wafer chucking surface; and
fixing a planar joint of the wafer chucking surface.

2. The method of claim 1 wherein placing the calibration jig on the wafer exchange surface comprises coupling the jig to the wafer exchange surface such that it is centered thereon.

3. The method of claim 1 wherein bringing the wafer chucking surface into flat contact with the calibration jig such that the first pin is received by one of the one or more openings on the wafer chucking surface comprises allowing the wafer chucking surface to rotate via the rotary joint.

4. The method of claim 1 wherein bringing the wafer chucking surface into flat contact with the calibration jig such that the second pin is received by one of the one or more openings on the wafer chucking surface comprises allowing the wafer chucking surface to translate via the planar joint.

5. The method of claim 1 wherein the rough calibration pin and the fine calibration pin extend into the same opening.

6. A method of calibrating a wafer chucking surface relative to a wafer exchange surface, comprising:
providing a wafer chucking surface;
providing a wafer exchange surface opposite the wafer chucking surface;
mounting at least one of the wafer chucking surface and the wafer exchange surface via a fixable rotary joint;
mounting at least one of the wafer chucking surface and the wafer exchange surface via a fixable planar joint;
coupling a calibration jig to a first one of the wafer chucking surface and the wafer exchange surface;
bringing the wafer chucking surface and the wafer exchange surface into flat contact with opposite faces of the calibration jig such that the wafer chucking surface and wafer exchange surface are leveled relative to each other, wherein the rough calibration pin extends from the calibration jig into a corresponding opening on a second one of the wafer chucking surface or the wafer exchange surface and wherein the calibration jig and the second one of the wafer chucking surface and the wafer exchange surface are adapted so as to be roughly concentric when the rough calibration pin extends into the opening;
fixing the rotary movement of the wafer chucking surface and/or the wafer exchange surface such that the wafer chucking surface and the wafer exchange surface are leveled relative to a each other;
reversing the position of the calibration jig;
bringing the wafer chucking surface and the wafer exchange surface into flat contact with opposite faces of the reversed calibration jig, wherein the fine calibration pin extends from the calibration jig into a corresponding opening on the second one of the wafer chucking surface or the wafer exchange surface and wherein the calibration jig and the second one of the wafer chucking surface and the wafer exchange surface are adapted so as to be finely concentric when the fine calibration pin extends into the opening.

7. The method of claim 6 wherein coupling the calibration jig to a first one of the wafer chucking surface and the wafer exchange surface comprises coupling the jig to the wafer exchange surface or the wafer chucking surface such that the jig is centered thereon.

8. The method of claim 6 wherein the rough calibration pin and the fine calibration pin extend into the same opening.

9. The method of claim 6 wherein bringing the wafer chucking surface and the wafer exchange surface into flat contact with the calibration jig such that the rough calibration pin is received by one of the one or more openings on the wafer chucking surface or the wafer exchange surface comprises allowing the wafer chucking surface to rotate via the rotary joint.

10. The method of claim 6 wherein bringing the wafer chucking surface and the wafer exchange surface into flat contact with the calibration jig such that the fine calibration pin is received by one of the one or more openings on the wafer chucking surface or the wafer exchange surface comprises allowing the wafer chucking surface to translate via the planar joint.

11. A method of calibrating a wafer chucking surface relative to a wafer exchange surface, comprising:
providing a wafer chucking surface;
providing a wafer exchange surface opposite the wafer chucking surface;
mounting at least one of the wafer chucking surface and the wafer exchange surface via a fixable rotary joint;
mounting at least one of the wafer chucking surface and the wafer exchange surface via a fixable planar joint;
coupling a first calibration jig to a first one of the wafer chucking surface and the wafer exchange surface;
bringing the wafer chucking surface and the wafer exchange surface/into flat contact with opposite faces of the first calibration jig such that the wafer chucking surface and wafer exchange surface are leveled relative to each other, wherein a rough calibration pin extends from the first calibration jig into a corresponding opening on a second one of the wafer chucking surface or the wafer exchange surface and wherein the first calibration jig and the second one of the wafer chucking surface and the wafer exchange surface are adapted so as to be roughly concentric when the rough calibration pin extends into the opening;
fixing the rotary movement of the wafer chucking surface and/or the wafer exchange surface such that the wafer chucking surface and the wafer exchange surface are leveled relative to a each other;
placing a second calibration jig between the wafer chucking surface and the wafer exchange surface, wherein the second calibration jig couples to a first one of wafer chucking surface or the wafer exchange surface so as to be concentric therewith;
bringing the wafer chucking surface and the wafer exchange surface into flat contact with opposite faces of the second calibration jig, wherein a fine calibration pin extends from the second calibration jig into a corresponding opening on the second one of the wafer chucking surface or the wafer exchange surface and wherein the second calibration jig and the second one of the wafer chucking surface and the wafer exchange surface are adapted so as to be finely concentric when the fine calibration pin extends into the opening.

12. The method of claim 11 wherein coupling the calibration jig to a first one of the wafer chucking surface and the wafer exchange surface comprises coupling the jig to the wafer exchange surface or the wafer chucking surface such that the jig is centered thereon.

13. The method of claim 11 wherein the rough calibration pin and the fine calibration pin extend into the same opening.

14. The method of claim 11 wherein bringing the wafer chucking surface into flat contact with the first calibration jig such that the rough calibration pin is received by one of the one or more openings on the wafer chucking surface comprises allowing the wafer chucking surface to rotate via the rotary joint.

15. The method of claim 11 wherein bringing the wafer chucking surface into flat contact with the second calibration jig such that the fine calibration pin is received by one of the one or more openings on the wafer chucking surface comprises allowing the wafer chucking surface to translate via the planar joint.

16. A wafer chuck comprising:
a wafer chucking surface;
at least one fixable rotary joint coupled to the wafer chucking surface so as to allow the wafer chucking surface to rotate so as to selectively adjust and fix the pitch of the wafer chucking surface; and
at least one planar joint coupled to the wafer chucking surface so as to selectively allow the wafer chucking surface to translate and to fix the position of the wafer chucking surface so as to center the wafer chucking surface with respect to another surface.

17. An assembly comprising a chamber having:
a wafer chucking surface;
a wafer exchange surface, opposite the wafer chucking surface;
at least one fixable rotary joint coupled to the wafer chucking surface so as to allow the wafer chucking surface to rotate so as to selectively adjust and fix the pitch of the wafer chucking surface so as to level the wafer chucking surface with respect to the wafer exchange surface; and
at least one planar joint coupled to the wafer chucking surface so as to selectively allow the wafer chucking surface to translate and to fix the position of the wafer chucking surface so as to center the wafer chucking surface with respect to the wafer exchange surface.

18. The apparatus of claim 17 further comprising:
a plate adapted to couple to a first one of the wafer exchange surface or the wafer chucking surface, the plate having a first planar surface and a second planar surface, a first calibration pin extending from the first planar surface, and a second calibration pin extending from the second planar surface, wherein a second one of the wafer exchange surface and the wafer chucking surface has an opening adapted to receive the first pin and the second pin, wherein the wafer chucking surface, the wafer exchange surface and the calibration jig are adapted such that the wafer exchange surface and the wafer chucking surface are roughly concentric when the first pin extends into the opening and such that the wafer chucking surface and the wafer exchange surface are finely concentric when the second calibration pin extends into the opening.

19. The apparatus of claim 17 further comprising:
a plate adapted to couple to a first one of the wafer chucking surface and the wafer exchange surface, the plate having a first planar surface and a first calibration pin extending from the first planar surface, wherein a second one of the wafer exchange surface and the wafer chucking surface has an opening adapted to receive the first pin, and wherein the wafer chucking surface, the wafer exchange surface and the calibration jig are adapted such that the wafer exchange surface and the wafer chucking surface are at least roughly concentric when the first pin extends into the opening of the wafer chucking surface.

20. The apparatus of claim 17 further comprising:
a plate adapted to couple concentrically to the water exchange surface, the plate having a first planar surface and a second planar surface, a first calibration pin extending from the first planar surface, and a second calibration pin extending from the second planar surface, wherein the wafer chucking surface has a first opening adapted to receive the first pin and a second opening adapted to receive the second pin, wherein the wafer chucking surface and the calibration jig are adapted such that the wafer exchange surface and the wafer chucking surface are roughly concentric when the first pin extends into the first opening of the wafer chucking surface and such that the wafer chucking surface and the wafer exchange surface are finely concentric when the second calibration pin extends into the second opening of the wafer chucking surface.

21. The apparatus of claim 17 wherein the first and second calibration pins extend perpendicularly from the respective planar surface.

22. An assembly comprising:
a wafer chucking surface;
a wafer exchange surface, opposite the wafer chucking surface;
at least one fixable rotary joint coupled to the wafer exchange surface so as to allow the wafer exchange surface to rotate so as to selectively adjust and fix the pitch of the wafer exchange surface so as to level the wafer exchange surface with respect to the wafer chucking surface;
at least one planar joint coupled to the wafer exchange surface so as to selectively allow the wafer exchange surface to translate and to fix the position of the wafer exchange surface so as to center the wafer exchange surface with respect to the wafer chucking surface.

23. The assembly of claim 22 further comprising:
a plate adapted to couple to a first one of the wafer exchange surface or the wafer chucking surface, the plate having a first planar surface and a second planar surface, a first calibration pin extending from the first planar surface, and a second calibration pin extending from the second planar surface, wherein a second one of the wafer exchange surface and the wafer chucking surface has an opening adapted to receive the first pin and the second pin, wherein the wafer chucking surface, the wafer exchange surface and the calibration jig are adapted such that the wafer exchange surface and the wafer chucking surface are roughly concentric when the first pin extends into the opening and such that the wafer chucking surface and the wafer exchange surface are finely concentric when the second calibration pin extends into the opening.

24. The apparatus of claim 22 further comprising:
a plate adapted to couple to a first one of the wafer chucking surface and the wafer exchange surface, the plate having a first planar surface and a first calibration pin extending from the first planar surface, wherein a second one of the wafer exchange surface and the wafer chucking surface has an opening adapted to receive the first pin, and wherein the wafer chucking surface, the wafer exchange surface and the calibration jig are adapted such that the wafer exchange surface and the wafer chucking surface are at least roughly concentric when the first pin extends into the opening of the wafer chucking surface.

25. The apparatus of claim 22 further comprising:
a plate adapted to couple concentrically to the wafer exchange surface, the plate having a first planar surface and a second planar surface, a first calibration pin extending from the first planar surface, and a second calibration pin extending from the second planar surface, wherein the wafer chucking surface has a first opening adapted to receive the first pin and a second opening adapted to receive the second pin, wherein the wafer chucking surface and the calibration jig are adapted such that the wafer exchange surface and the wafer chucking surface are roughly concentric when the first pin extends into the first opening of the wafer chucking surface and such that the wafer chucking surface and the wafer exchange surface are finely concentric when the second calibration pin extends into the second opening of the wafer chucking surface.

26. The apparatus of claim 22 wherein the first and second calibration pins extend perpendicularly from the respective planar surface.
